(19) United States
(12) Patent Application Publication
(10) Pub. No.: US 2014/0129401 A1
(43) Pub. Date: May 8, 2014

(54) System and Method to Quantify the Economic Value of Performance Management and Training Programs

(71) Applicants: Walter Kruz, Sunnyvale, CA (US); Fay Wong, Sunnyvale, CA (US)

(72) Inventors: Walter Kruz, Sunnyvale, CA (US); Fay Wong, Sunnyvale, CA (US)

(21) Appl. No.: 13/668,242

(22) Filed: Nov. 3, 2012

(51) Int. Cl. G06Q 40/00

(52) U.S. Cl. CPC G06Q 40/00
USPC 705/35

(57) ABSTRACT

A system and method are provided to quantify the monetary effect of risk reduction when calculating the return on investments made on performance management and training programs. The system includes an operational platform comprising one or more computers, computer networks, and databases. The method includes processes that create and quantify risk profiles specific to various business models used to monetize the risk reduction or benefit created by training. This monetary benefit is used to calculate the return on investment on performance management and training programs.

### CROSS-REFERENCE TO RELATED APPLICATION

This application claims the benefit of U.S. Provisional Application No. 61/556,284, filed Nov. 6, 2011.
Application No. 61/556,284
Filing Date Nov. 6, 2011
Confirmation No. 8350
Applicants:
   Walter Kruz, Sunnyvale, Calif.
   Fay Wong, Sunnyvale, Calif.
Title: Process and Method to Quantify the Economic Value of Training and Development Programs
Application Type: Provisional

### BACKGROUND OF THE INVENTION

This invention relates to systems and methods for quantifying the economic value of performance management and training programs, and more particularly, to a system and method to quantify and monetize the risk profile associated with various business models and the risk reduction effected by training and performance management programs. It quantifies the Return on Investment (ROI) of a given training investment by identifying and evaluating the economic value of the operational risk reduction brought about by training programs. The method provided here establishes a relationship between risk and the effect of training programs in reducing such risks. This method generally applies to any business models where risk is a consideration and especially to those business models where the risk of failure carries tragic consequences to the business and to local communities.

### DESCRIPTION OF THE RELATED ART

Authors such as Donald Kirkpatrick (in Tobin 2009) and Jack Phillips (2005) have published models that attempt to evaluate the business value of training. The most widely used method for evaluating the effect of training programs today is the model first introduced in 1959 by Dr. Donald Kirkpatrick. The four levels of evaluation included in the Kirkpatrick model are: 1). Reaction: on a very basic level, how do the students feel about the training they received? Simply approaches suck as surveys and course evaluations given to students and generate conclusion of the training are traditional methods for measuring reactions. 2). Learning: do the students retain this information? Testing provides a good means of evaluating learning, and does provide a quantifiable result in terms of pass/fail ratios and percentages. 3). Application (Behavior): do the students take what they learned and modify their behaviors based on it? This most likely requires observation by a manager or supervisor to see if the students are using the appropriate knowledge and skills. 4). Business Impact (Results): did the training produce any quantifiable results (such as increase productivity or increase customer satisfaction)? This is the stage of the Kirkpatrick evaluation process that seeks to find the numbers that define how well a training program worked for the company. One or more business impact segments are selected and business impact data is collected and reviewed.

Phillips (1991) added a fifth level of evaluation, known as Return on Investment (ROI) to compare the monetary value of the results of training programs with the costs for the program, usually expressed as a percentage. This level takes an extra step to convert business impact data to monetary units so that the benefits can be compared to costs, which in turn leads to an ROI calculation. A four-step approach is used to complete the ROI calculation: Planning, Data Collection, Data Analysts, and Reporting.

While the Kirkpatrick-Phillips methods offers a general quantitative approach to calculating the value of training programs, the invention disclosed herein has certain additional benefits in furthering the ability to calculate the economic value of these programs. Because risk is an intrinsic component of various business models, this invention develops the method that creates specialized risk profiles and their respective economic value. The inclusion of the economic value of risk provides organizations additional visibility and precision when ascertaining the benefit of individual training programs and, eventually, the organizational ROI.

### BRIEF SUMMARY OF THE INVENTION

The present invention establishes a relationship between business operational risks and the effect of performance management and training programs in reducing such risks. It provides a system and method for including the economic value of risk in evaluating training Return on Investment. The method provides a series of steps to capture information regarding risks associated with specific business models, creating quantitative risk profiles, and calculating their monetary value under normal conditions and under worst case assumptions. The difference between normal and worst conditions is the Risk Liability SPREAD; and an estimated Self-Insured Cost of the Risk Liability SPREAD is the risk reduction or benefit brought about by training. The benefit value can be used in calculating the organizational and specific program ROI.

Although the system and method described herein refers specifically to training programs, it shall be understood that the system and method of this invention can be utilized for any type of performance management programs where risk is an element of the business model being affected.

The present invention comprises an Organization Framework and a Program Framework; wherein said Organization Framework calculates the economic value of training at the organizational level, and wherein said Program Framework calculates the economic value of training at the individual program level; wherein said Organization Framework and Program Framework each comprises a Risk Identification Module, a Risk Impact Calculation Module, a Risk Reduction Benefits Calculation Module, and a training ROI Calculation module respectively. Within the Organization Framework, the Risk Identification Module produces a Risk Profile comprising sets of Risk Events associated with a business organization; the Risk Impact Calculation Module quantifies Risk Events liability costs—based on Worse Case situation (TML) where there is no training program in place and Normal situation (NOL) where training programs have been implemented; the Risk Reduction Benefits Calculation Module calculates the total Risk Reduction Benefits by determining the cost difference between TML and NOL (Risk Liability SPREAD), and estimating a Self-Insured Cost; and isolates the training contribution to the total Risk Reduction Benefits; the training ROI Calculation module calculates the training Organization Return on Investment by comparing the Risk Reduction Benefits brought about by its training programs and the organization's total training investment.

Within the Program Framework, the Risk Identification Module produces a Risk Checklist comprising a set of Risk Events associated with a particular training program; The Risk Impact Calculation Module quantifies Risk Events costs to the business before training program implementation (AS-IS Prior Training), improvement forecast (TO-BE), and after training program implementation (AS-IS Post Training); the Risk Reduction Benefits Calculation Module calculates the cost different between AS-IS Prior Training and AS-IS Post Training—interpreted as total Risk Reduction Benefits; and isolates the training program contribution to the total Risk Reduction Benefits; the training Program ROI Calculation Module calculates the training program's Total Program Cost by adding up its direct costs and in-direct costs, and calculates the Program ROI by comparing the Risk Reduction Benefits contributed by the training program and the Total Program Cost.

The method is best integrated and executed within a networked computing system which can include one or more computer and database.

### BRIEF DESCRIPTION OF THE SEVERAL VIEWS OF THE DRAWING

FIG. 1 is a block view according to the first embodiment of the present invention; and

FIG. 2A is a process flowchart showing a state of use of the Organization Framework according to the first embodiment of the present invention, and

FIG. 2B is a process flowchart showing a state of use of the Program Framework according to the first embodiment of the present invention, and

FIG. 3 is a user view of the process according to the first embodiment of the present invention

### DETAILED DESCRIPTION OF THE INVENTION

The following description of the first embodiment is provided to understand the features and the structures of the present invention.

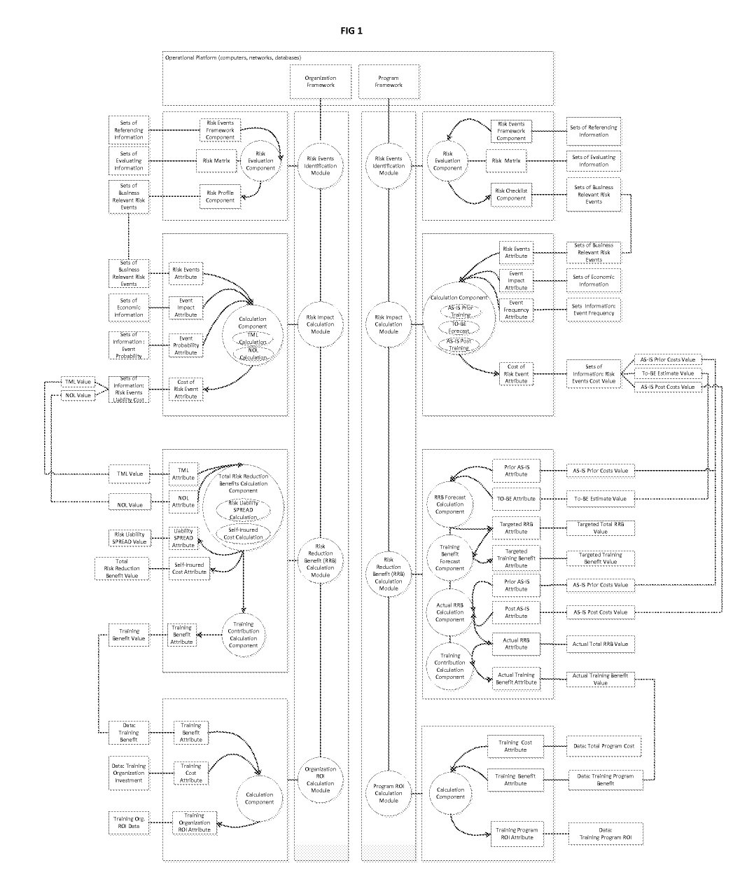

Please refer to FIG. 1, which is a block view according to the first embodiment of the present invention.
As shown in the figure, the present invention provides an operational platform comprising a networked computing system with one or more computer and database. The operational platform contains a method comprising an Organization Framework and a Program Framework.
The Organization Framework comprises a Risk Events Identification Module, a Risk Impact Calculation Module, a Risk Reduction Benefit Calculation Module, and an Organizational ROI Calculation Module. The Organization Framework enables users to calculate the monetary value of operational risk reduction brought about by all training programs implemented by the organization.
The said Risk Events Identification module within the Organization Framework comprises a Risk Events Framework component, a Risk Events Evaluation component, and a Risk Profile component; wherein said Risk Event Framework component comprises Sets of Referencing Information—possible risk events associate with business; wherein Sets of Referencing Information can be created manually or obtained from external source, based on business operation or industry data; wherein said Risk Event Evaluation component contains a Risk Matrix providing Sets of Evaluating Information for risk events assessment and prioritization; wherein said Sets of Referencing Information of Risk Event Framework can be processed by Risk Event Evaluation component, and produce Sets of Business Relevant Risk Events; wherein said Sets of Business Relevant Risk Events can enter into Risk Profile component, and become a Risk Profile.
The said Risk Impact Calculation Module within the Organization Framework comprises a Risk Events attribute, an Event Impact attribute, an Event Probability attribute, and a Cost of Risk Event attribute; wherein said Risk Events attribute contains Sets of Business Relevant Risk Events come from the Risk Profile; wherein said Event Impact attribute contains Sets of Economic Information represents each Risk Event's respective economic impact; wherein said Sets of Economic Information come from business operation data or industry data; wherein said Event Probability attribute contains Sets of Probability Information represents each Risk Event's respective Probability of occurring; wherein said Sets of Economic Information of Event Impact and Sets of Probability Information of Event Probability can be processed using the equation Event Impact×Event Probability=Cost of Risk Event, and the output of this processing become the input of the said Cost of Risk Event attribute.
The said Risk Impact Calculation Module within the Organization Framework comprises a TML calculation component, and a NOL calculation component; wherein said TML calculation component calculates a Risk Profile's Maximum Cost of Risk Event where Worst Case Sets of Probability Information of Event Probability are used for Probability attribute; wherein said NOL calculation component calculates a Risk Profile's Normal Cost of Risk Event where industry standard Sets of Probability Information of Event Probability are used for Probability attribute.
The said Risk Reduction Benefit Calculation Module within the Organization Framework comprises a Total Risk Reduction Benefit calculation component, and a Training Contribution calculation component; the Total Risk Reduction Benefits Calculation Module calculates the total risk reduction benefits by determining the cost difference between TML and NOL (Risk Liability SPREAD), and estimating a Self-Insured Cost; wherein said Training Contribution calculation component calculate the Risk Reduction Benefit attributed to Training programs alone—isolate the Training programs contribution from other factors resulting in risk reduction benefit brought to the business; wherein said Training Contribution calculation component extracts data from the said Total Risk Reduction Benefit calculation component, and calculates Training Contribution using a apportionment approach: Training Contribution=Total Risk Reduction×Apportionment %
The said Organization ROI Calculation Module within the Organization Framework comprises a Training Cost attribute, a Training Benefit attribute, and a Training Organization ROI attribute; wherein said Training Cost attribute contain data of total organization training investment; wherein said Training Benefit attribute extracts data from the said Training Contribution calculation component, and use Training Contribution data as its input; wherein said Training Organization ROI attribute extracts data from said Training Cost attribute and Training Benefit attribute, and calculate training Organization ROI using this formula:

Organization ROI=[(Training Benefit−Training Cost)/Training Cost]×100%
The Program Framework comprises, at the individual training program level, a Risk Events Identification Module, a Risk Impact Calculation Module, a Risk Reduction Benefit Calculation Module, and a Program ROI Calculation Module. The Program Framework enables users to calculate the monetary value of operational risk reduction brought about by individual training programs implemented by the organization. Comparison of the risk reduction monetary values against the individual training program cost enables the calculation of training ROI by the firm at individual training program level.
The said Risk Events Identification module within the Program Framework comprises a Risk Events Framework component, a Risk Events Evaluation component, and a Risk Checklist component; wherein said Risk Event Framework component comprises Sets of Referencing Information—possible risk events associate with a business; wherein Sets of Referencing Information can be updated and edited according to business operation information or industry data; wherein said Risk Event Evaluation component contains a Risk Matrix providing Sets of Evaluating Information for risk events assessment and prioritization; wherein said Sets of Referencing Information of Risk Event Framework are processed by Risk Event Evaluation component, and produce Sets of Business Relevant Risk Events associated with individual Training Program; wherein said Sets of Business Relevant Risk Events are entered into Risk Checklist component, and become a Risk Checklist.
The said Risk Impact Calculation Module within the Program Framework comprises a Risk Events attribute, an Event Impact attribute, an Event Frequency attribute, and a Cost of Risk Event attribute; wherein said Risk Events attribute contains Sets of Business Relevant Risk Events associated with an individual Training Program come from the Risk Checklist; wherein said Event Impact attribute contains Sets of Economic Information represents each Risk Event's respective economic impact; wherein said Sets of Economic Information come from business operation data or industry data; wherein said Event Frequency attribute contains Sets of Frequency Information representing each Risk Event's respective Frequency of occurring; wherein said Sets of Economic Information of Event Impact and Sets of Frequency Information of Event Probability are processed using the equation: Event Impact×Event Frequency=Cost of Risk Event, and the output of this processing becomes the input of the said Cost of Risk Event attribute.
The said Risk Impact Calculation Module within the Program Framework comprises a AS-IS Prior Training Calculation component, a TO-BE Calculation component, and a AS-IS Post Training Calculation component; wherein said risk impact AS-IS Prior Training Calculation component calculates a Risk Checklist's Cost of Risk Event prior Training Program is implemented, and where Sets of Frequency Information of Risk Event Occurring prior training program implementation are used for Frequency attribute; wherein said TO-BE Calculation component calculates a Risk Checklist's expected Cost of Risk Event post training program implementation, where Sets of Targeting Frequency Information of Event Occurring are used for Frequency attribute; wherein said AS-IS Post Training Calculation component calculates a Risk Checklist's Cost of Risk Event post training program implementation, where Sets of Frequency Information of Risk Event Occurring post training program implementation are used for Frequency attribute.
The said Risk Reduction Benefit Calculation Module within the Program Framework comprises a Risk Reduction Benefit Forecast (RRB Forecast) Calculation component, an Actual Risk Reduction Benefit (Actual RRB) Calculation component, and a Training Contribution Calculation component; wherein said Risk Reduction Benefit Forecast calculation component calculates the cost difference between AS-IS Prior Training and TO-BE, interpreted as the Expected reduction in risk, or benefit, brought about by implementation of the Training program and other factors: Total Risk Reduction Benefit Forecast=AS-IS Prior Training−TO-BE; wherein said Actual Risk Reduction Benefit Calculation component calculates the cost different between AS-IS Prior Training and AS-IS Post Training, interpreted as the actual reduction in risk, or benefit, brought about by implementation of the training program and other factors:

Actual Total Risk Reduction Benefit=AS-IS Prior Training−AS-IS Post Training; wherein said Training Contribution Calculation component calculates the Risk Reduction Benefit attributed to the training program alone—isolating the training program contribution from other factors resulting in risk reduction benefit brought to the business; wherein said Training Contribution calculation component can pull data from the said Risk Reduction Benefit Forecast calculation component or the said Actual Risk Reduction Benefit calculation component, and process Training Contribution using a apportionment approach: Training Contribution=Total Risk Reduction×Apportionment %
The said Program ROI Calculation Module within the Program Framework comprises a Training Cost attribute, a Training Benefit attribute, and a training Program ROI attribute; wherein said Training Cost attribute contain data summarizing the training program total cost amount; wherein said Training Benefit attribute extracts data from the said Training Contribution Calculation component, and use Training Contribution data as its input; wherein said Training Program ROI attribute extracts data from said Training Cost attribute and Training Benefit attribute, and calculate training Program ROI using this formula: Program ROI=[(Training Benefit−Training Cost)/Training Cost]×100%

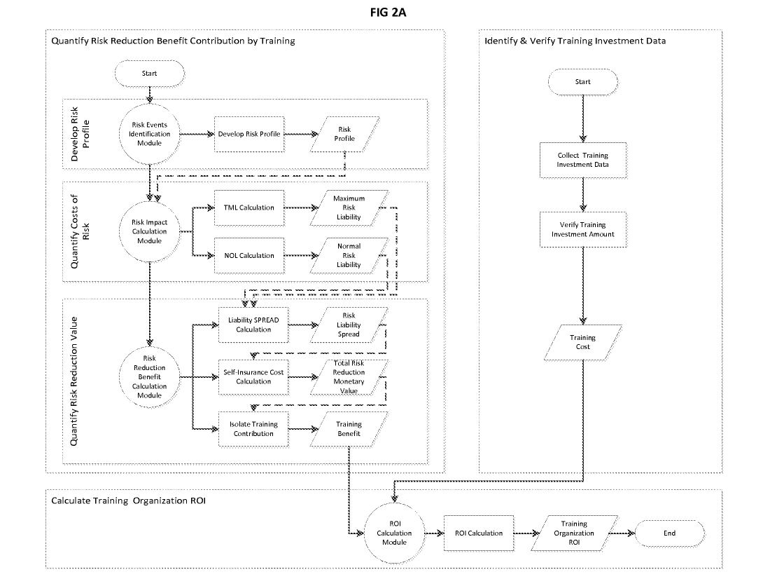

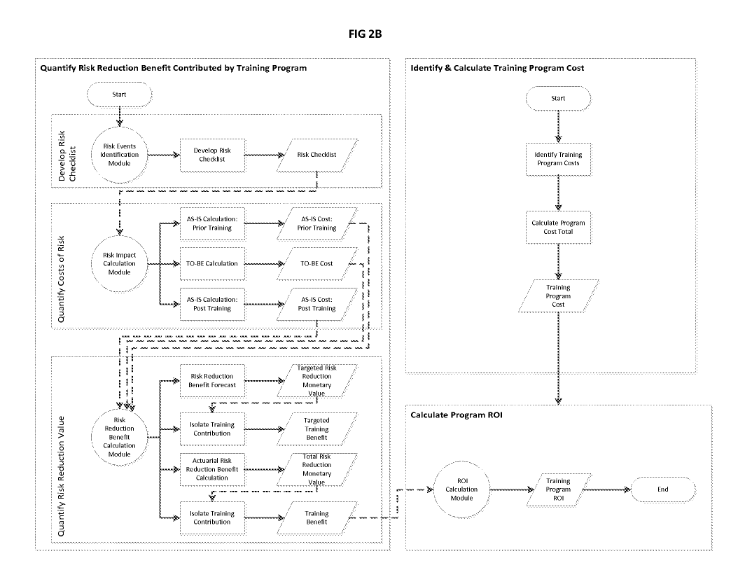

Please refer to FIG. 2A which is a process flowchart showing a state of use of the Organization Framework according to the first embodiment of the present invention. As shown in the figure, when using the method, training costs are identified and verified prior to factoring these in the Organization ROI Calculation Module. A Risk Profile is developed containing all risks associated with the business model and included in training programs by means of the Risk Events Identification module; and the monetary value of these risks is calculated by means of the Risk Impact Calculation Module. Calculation of the Liability SPREAD, the Self-Insured Cost, and isolating the effect of training programs alone in total risk reduction, enables the calculation of the monetary value of Training—operational risk reduction benefits contributed by training. Finally, all the described modules are entered into the training Organization ROI Calculation Module to calculate the ROI obtained by the organization.

Please refer to FIG. 2B which is a process flowchart showing a state of use of the Program Framework according to the first embodiment of the present invention. As shown in the figure, training program costs are identified and total program cost is aggregated and entered into the Program ROI Calculation Module. The Risk Events Identification Module enables the identification of those risks applicable to the specific training program. The Risk Impact Calculation enables the AS IS Prior Training Calculation, as well as the AS IS Post Training Calculation. A TO BE risk impact estimate is also created in this module. The Risk Reduction Benefit Calculation Module includes calculation of a Forecast overall Risk Reduction Benefit, Actual overall Risk Reduction Benefit, the calculated isolation of training contribution to overall risk reduction. These modules are all factored into the Program ROI Module that calculates the training Program ROI.

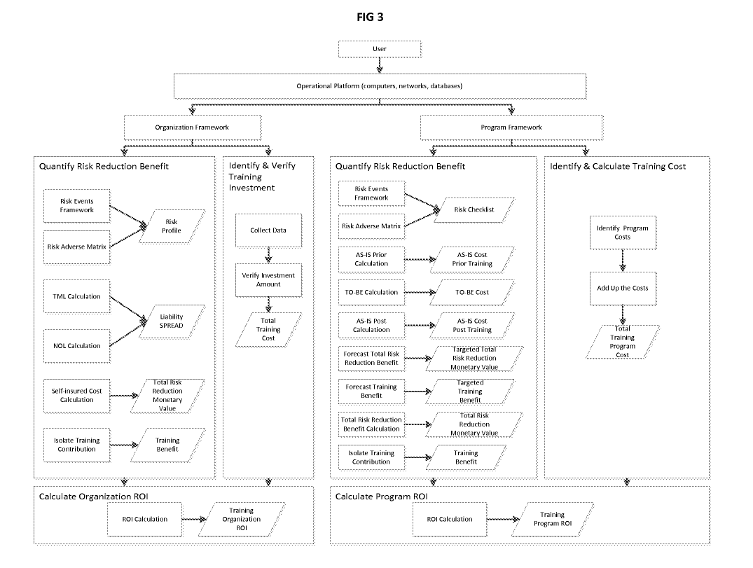

Please refer to FIG. 3, which shows a user view of the process according to the first embodiment of the present invention. As shown in the figure, a user access the system through an operational platform made up of one or more computer, a computer network, and database. Risk information and calculation components described above are available to populate the modules enabling calculations for both organization and program ROI.

### CONCLUSION

To summarize, the present invention is an operational platform including various modules designed to monetize the value of operational risk reduction and thus enable the calculation of the Return on Investment gain from performance management and training investments made by an organization at both the Organization and the individual Program level.

The first embodiment herein disclosed is not intended to necessarily limit the scope of the invention. Therefore, simple modifications or variations belonging to the equivalent of the scope of the claims and instructions disclosed herein for a patent are all within the scope of the invention.

What is claimed is:

1. A method to quantify the economic value of training and performance management programs, comprising an operational platform; said operational platform is a networked computing system comprising one or more computers and databases, and contains an Organization Framework and a Program Framework; wherein said Organization Framework calculates the economic value of training at the organizational level, and wherein said Program Framework calculates the economic value of training at the individual program level

2. The method according to claim 1, wherein said Organization Framework comprises a Risk Events Identification Module, a Risk Impact Calculation Module, a Risk Reduction Benefit Calculation Module, and a Training Organization Return on Investment (Organization ROI) Calculation Module

3. The method according to claim 2, wherein said Risk Events Identification Module comprises a Risk Events Framework component, a Risk Events Evaluation component, and a Risk Profile component; wherein said Risk Event Framework component comprises Sets of Referencing Information; wherein said Risk Event Evaluation component contains a Risk Matrix providing Sets of Evaluating Information for risk events assessment and prioritization; wherein said Risk Events Identification module enable the creation of Risk Profiles containing Sets of Business Relevant Risk Events

4. The method according to claim 2, wherein said Risk Impact Calculation Module comprises a Risk Events attribute, an Event Impact attribute, an Event Probability attribute, and a Cost of Risk Event attribute; wherein said Risk Events attribute contains Sets of Business Relevant Risk Events; wherein said Event Impact attribute contains Sets of Economic Information represents each Risk Event's respective economic impact; wherein said Event Probability attribute contains Sets of Probability Information represents each Risk Event's respective Probability of occurring; wherein said Risk Impact Calculation Module enables the calculation of the said Risk Profile's cost of risks

5. The method according to claim 2, wherein said Risk Impact Calculation Module comprises a Total Maximum Liability (TML) calculation component, and a Normal Operation Liability (NOL) calculation component; wherein said Total Maximum Liability calculation component calculates a Risk Profile's Maximum Cost of Risk Event where Worst Case Sets of Probability Information of Event Probability are used for Probability attribute; wherein said Normal Operation Liability calculation component calculates a Risk Profile's Normal Cost of Risk Event

6. The method according to claim 2, wherein said Risk Reduction Benefit Calculation Module comprises a Total Risk Reduction Benefit calculation component, and a Training Contribution calculation component; wherein said Total Risk Reduction Benefit calculation component calculates the Total Risk Liability SPREAD and estimates a Self-Insured Cost; wherein said Training Contribution calculation component calculates the Risk Reduction Benefit attributed to Training programs alone; wherein said Training Contribution calculation component extracts data from the said Total Risk Reduction Benefit calculation component, and process Training Contribution using an apportionment approach

7. The method according to claim 2, wherein said Organization Return on Investment Calculation Module comprises a Training Cost attribute, a Training Benefit attribute, and enable the calculation of Training Organization Return on Investment by comparing the training organization Risk Reduction Benefit and Training Cost

8. The method according to claim 1, wherein said Program Framework comprises a Risk Events Identification module, a Risk Impact Calculation Module, a Risk Reduction Benefit Calculation Module, and a Training Program Return on Investment (Program ROI) Calculation Module

9. The method according to claim 8, wherein said Risk Events Identification module comprises a Risk Events Framework component, a Risk Events Evaluation component, and a Risk Checklist component; wherein said Risk Event Framework component comprises Sets of Referencing Information; wherein said Risk Event Evaluation component contains a Risk Matrix providing Sets of Evaluating Information for risk events assessment and prioritization; wherein said Risk Events Identification Module enables the creation of Risk Checklist containing Set of Business Relevant Risk Events associated with individual performance management and training program

10. The method according to claim 8, wherein said Risk Impact Calculation Module comprises a Risk Events attribute, an Event Impact attribute, an Event Frequency attribute, and a Cost of Risk Event attribute; wherein said Risk Events attribute contains Sets of Business Relevant Risk Events associated with an individual performance management and training Program; wherein said Event Impact attribute contains Sets of Economic Information represents each Risk Event's respective economic impact; wherein said Event Frequency attribute contains Sets of Frequency Information represents each Risk Event's respective Frequency of occurring; wherein said Risk Impact Calculation Module enables the calculation of the said Risk Checklist's cost of risks

11. The method according to claim 8, wherein said Risk Impact Calculation Module comprises a AS-IS Prior Training calculation component, a TO-BE calculation component, and a AS-IS Post Training Calculation component

12. The method according to claim 8, wherein said Risk Reduction Benefit Calculation Module comprises a Risk Reduction Benefit Forecast (RRB Forecast) calculation component, an Actual Risk Reduction Benefit (Actual RRB) calculation component, and a Training Contribution Calculation component; wherein said Risk Reduction Benefit Calculation enables the calculation of risk reduction monetary value created by individual training program

13. The method according to claim 8, wherein said Training Program Return on Investment (Program ROI) Calculation Module comprise a Training Cost attribute, a Training Benefit attribute, and enables the calculation of performance management and training Program Return on Investment by comparing the individual Program Risk Reduction Benefit and Program Cost.
